(19) United States
(12) Patent Application Publication
(10) Pub. No.: US 2017/0351987 A1
(43) Pub. Date: Dec. 7, 2017

(54) MATCHING FLEXIBLE USERS IN A TRAVEL COORDINATION SYSTEM

(71) Applicant: Uber Technologies, Inc., San Francisco, CA (US)

(72) Inventor: Yifang Liu, Burlingame, CA (US)

(21) Appl. No.: 15/175,012

(22) Filed: Jun. 6, 2016

(51) Int. Cl. G06Q 10/06; H04L 29/08; G06F 3/0484

(52) U.S. Cl. CPC G06Q 10/06311; G06F 3/0484; H04L 67/18

(57) ABSTRACT

A travel coordination system allows users to submit flexible trip requests that allow the users to be matched with either riders or providers. A flexible user can submit a flexible trip request that can include a start location or a destination location. The flexible trip request may include matching preferences that the travel coordination system uses to determine whether to match the flexible user with a rider or a provider. The travel coordination system determines whether to match the flexible user with a rider or a provider. The travel coordination system may match the flexible user with a rider or a provider based on provider supply or trip demand. The travel coordination system may also establish a preferred and a dispreferred matching group, and may match the flexible user with a member of the preferred matching group before matching the flexible user with a member of the dispreferred matching group.

### BACKGROUND

The present disclosure relates generally to travel coordination systems.

Travel coordination systems provide a means of travel by connecting users who need rides (i.e., “riders”) with users who can drive them (i.e. “providers”). A rider can submit a request for a ride to the travel coordination system and the travel coordination system selects a provider to service the request by transporting the riding to their intended destination.

Conventionally, a rider makes a trip request to the travel coordination system, and the travel coordination system attempts to match the rider with a provider. The number of riders that may want to request transportation and the number of providers available to provide transportation may vary at different times. Conventional travel coordination systems do not have control over the demand for trips and supply of providers within a geographic region, meaning that a discrepancy between the trip demand and provider supply is more likely to occur.

### SUMMARY

A travel coordination system receives flexible trip requests that allow users to be matched as either a rider or a provider. These “flexible users” may be selected for a role as rider or provider according to various factors in the geographic region, such as the supply of providers and demand by riders. A flexible user submits a flexible trip request that can include a start location or a destination location. The start location may be a pick-up location for the flexible user, or may be the location from where the flexible user will start their trip. The flexible trip request may also include matching preferences for the flexible user that the travel coordination system uses to determine whether to match the flexible user with a rider or a provider. For example, the matching preferences may include a maximum detour distance or time the flexible user is willing to travel to be matched with a rider.

The travel coordination system determines whether to match the flexible user with a rider or a provider based on the flexible trip request. In some embodiments, the travel coordination system matches the flexible user with a rider or a provider based on the supply of providers or demand for trips in a geographic region. For example, if provider supply is low and trip demand is high, the travel coordination system may match the flexible user with a rider to service part of the high demand for trips. In such an example, the flexible user would become the provider of the trip for the rider. The travel coordination system can determine the provider supply and trip demand based on provider supply factors and trip demand factors respectively, and those factors may be used to determine models of the provider supply and trip demand that can be used to match the flexible user. In some embodiments, the travel coordination system establishes a preferred and a dispreferred matching group, and matches the flexible user with a member of the preferred matching group before matching the flexible user with a member of the dispreferred matching group. For example, if the travel coordination system establishes riders as the preferred matching group and providers as the dispreferred matching group, the travel coordination system might try to match the flexible user with riders before trying to match the flexible user with a provider in the geographic region.

By allowing a flexible user to be matched with either a rider or a provider, the travel coordination system disclosed herein has significant benefits when compared to conventional travel coordination systems. The disclosed travel coordination system is provided additional flexibility to match the flexible user based on the needs of the travel coordination system. For example, if the travel coordination system matches the flexible user based on provider supply and trip demand, the travel coordination system can ensure that providers that are available to provide transport are assigned to riders and can ensure that riders are being provided with rides as quickly as possible. To encourage users to submit flexible trip requests, the travel coordination system may guarantee a flat rate to the flexible user for the ride, may discount the price of the trip if the user is matched a provider, or may reduce the travel coordination system's commission for organizing the trip if the user is matched with a rider.

### BRIEF DESCRIPTION OF THE DRAWINGS

Figure (FIG. 1 illustrates an example system environment and architecture for a travel coordination system, in accordance with some embodiments.

FIG. 2 illustrates a method for matching a flexible user with another user, in accordance with some embodiments.

FIG. 3 illustrates a method for matching a flexible user with another user by establishing a preferred matching group, in accordance with some embodiments.

FIG. 4 illustrates an example user interface to submit a flexible trip request to a travel coordination system, in accordance with some embodiments.

FIG. 5 illustrates an example hardware architecture of a computer system, such as a travel coordination system, in accordance with some embodiments.

FIG. 6 illustrates an example hardware architecture of a mobile device, such as a client device, in accordance with some embodiments.

### DETAILED DESCRIPTION

### Example System Environment and Architecture

FIG. 1 illustrates an example system environment and architecture for a travel coordination system 120, in accordance with some embodiments. The illustrated system environment includes a client device 100, a network 110, and a travel coordination system 120. Alternate embodiments may include more, fewer, or different components in the system environment, and the functionality of each component may be distributed differently from the examples herein.

A user can interact with the travel coordination system 120 through a client device 100 to request transportation or to receive requests to provide transportation. While examples described herein relate to a transportation service, the travel coordination system 120 can enable other services to be requested by requesters, such as a delivery service, food service, entertainment service, etc., in which a provider is to travel to a particular location. As described herein, a client device can be a personal or mobile computing device, such as a smartphone, a tablet, or a computer. In some embodiments, the personal computing device executes a client application that uses an application programming interface (API) to communicate with the travel coordination system 120 through the network(s) 110.

Through operation of the client device 100, a rider can make a trip request to the travel coordination system 120. According to an example, a trip request can include user identification information, the number of passengers for the trip, a requested type of the provider (e.g., a vehicle type or service option identifier), the current location and/or the pickup location (e.g., a user-specific location, or a current location of the client device 100), and/or the destination for the trip. The current location of the client device 100 may be designated by the rider, or detected using a location sensor of the client device 100 (e.g., a global positioning system (GPS) receiver).

A provider can use the client device 100 to interact with the travel coordination system 120 to identify riders to whom the provider can provide transportation. In some embodiments, the provider is a person operating a car, bicycle, bus, truck, boat, or other motorized vehicle capable of transporting passengers. In some embodiments, the provider is an autonomous vehicle that receives routing instructions from the travel coordination system 120. For convenience, this disclosure generally uses a car with a driver as an example provider. However, the embodiments described herein may be adapted for a provider operating these alternative vehicles.

A provider can receive assignment requests through the client device 100. An assignment request identifiers a rider who submitted a trip request to the travel coordination system 120 and who is assigned to the provider for a trip. For example, the travel coordination system 120 can receive a trip request from a client device 100 of a rider, select a provider from a pool of available (or “open”) users to provide the trip, and transmit an invitation message or assignment request to the selected user's client device 100. In some embodiments, a provider can indicate availability for receiving assignment requests. This availability may also be referred to herein as being “online” (available to receive assignment requests) or “offline” (unavailable to receive assignment requests). For example, a provider can decide to start receiving assignment requests by going online (e.g., by launching a client application or providing input on the client application to indicate that the provider wants to receive invitations), and stop receiving assignment requests by going offline. In some embodiments, when a client device 100 receives an assignment request, the provider has the option of accepting or rejecting the assignment request. By accepting the assignment request, the provider is assigned to the rider, and is provided the rider's trip details, such as pickup location and trip destination location. In one example, the rider's trip details are provided to the client device 100 as part of the invitation or assignment request.

In addition, the client device 100 allows a user to submit a flexible trip request. A flexible trip request indicates that the user submitting the request may be treated as either a rider or a provider, and may be matched with either a provider or a rider respectively. For example, the flexible rider may be a user that has the capacity to be a provider (i.e., has a vehicle and could accept a rider), but is also willing to share a trip as a rider for another provider. A flexible trip request can include similar information as a trip request, such as trip details including a pick-up location and a destination location. In some embodiments, the flexible trip request includes a start location for the flexible user, where the start location of the flexible user can be the current location of the flexible user's client device 100 or a pick-up location for a provider assigned to the flexible user. The flexible trip request further indicates that the user who submitted the flexible trip request, termed a “flexible user,” can be matched with either a rider or a provider. If matched with a rider, the flexible user is assigned to transport the rider from the rider's pick-up location to the rider's destination. If matched with a provider, the provider is assigned to provide transportation to the flexible user from the flexible user's start location to the flexible user's destination.

The client device 100 may interact with the travel coordination system 120 through a client application configured to interact with the travel coordination system 120. The client application of the client device 100 can present information received from the travel coordination system 120 on a user interface, such as a map of the geographic region, and the current location of the client device 100. In some embodiments, the client device 100 can include a location sensor, such as a global positioning system (GPS) receiver, that can determine the current location of the respective device (e.g., a GPS point). The client application running on the client device 100 can determine the current location and provide the current location to the travel coordination system 120.

The client device 100 can communicate with the travel coordination system 120 via the network 110, which may comprise any combination of local area and wide area networks employing wired or wireless communication links. In one embodiment, the network 110 uses standard communications technologies and protocols. For example, the network 110 includes communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 110 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 110 may be represented using any format, such as hypertext markup language (HTML) or extensible markup language (XML). In some embodiments, all or some of the communication links of the network 110 may be encrypted.

The travel coordination system 120 illustrated in the example of FIG. 1 includes travel data collection module 130, a travel data collection module 140, a user profile store 150, a matching module 160, a user interface generation module 170, and a trip price determination module 180. Alternate embodiments may include more, fewer, or different components. Conventional components such as web servers, network interfaces, security functions, load balancers, failover servers, management and network operations consoles, and the like are not shown so as to not obscure the details of the system architecture.

The travel data collection module 130 collects data about geographic regions in which the travel coordination system 120 matches riders with providers. The travel data collection module 130 may collect data using the client device 100 or from third party systems. Data collected by the travel data collection module 130 can include user profile data, traffic condition data, provider supply data, and trip demand data. The travel data collection module 130 may also collect information about trips taken using the travel coordination system 120, such as the start and end locations of trips, the start and end times of trips, identification information of the rider and provider, the distance and duration of the trip, the number of passengers on the trip, the time at which the rider requested the trip, the route taken on the trip, or the price of the trip. In addition, the travel data collection module 130 may collect data used to determine a trip price, such as provider supply data, trip demand data, and traffic condition data.

The travel data store 140 stores data collected by the travel data collection module 130. The travel data store 140 may also store data generated by the travel coordination system 120, such as models for provider supply and trip demand. In some embodiments, the travel data store 140 stores historical data that is used to generate models of the provider supply and trip demand. The travel data store 140 may categorize data based on a particular geographic region, a rider, or a provider with which the data is related.

The user profile store 150 stores user profile data for users of the travel coordination system 120. Each user of the travel coordination system 120 may have a user profile with which the user profile data associated with the user is associated. The user profile data can include the user's name, an account name or identifier, an email address, a home or work address, payment information, travel history of the user, and/or a user rating. The user profile data may further include whether the user can provide transportation to a rider, the type of vehicle the user owns, how often the user is available to provide rides to other users, and how often the user accepts assignment requests. In addition, the user profile store 150 may store matching preferences for a flexible user, which are described further below.

The matching module 160 matches a flexible user with a rider or a provider in response to receiving a flexible trip request from the flexible user. The matching module 160 may use matching preferences to determine whether to match the flexible user with a rider or a provider. Matching preferences describe parameters used by the travel coordination system 120 to evaluate riders and providers to be matched with the flexible user. In some embodiments, the matching module 160 stores the matching preferences as system default parameters for matching a flexible user. A flexible user may specify replacement default parameters to be used instead of the system default parameters when matching the flexible user with a rider or a provider. These replacement default parameters may be associated with the flexible user's account in the user profile data store 150. The flexible user may also specify matching preferences in a flexible trip request for use in matching that trip request.

The matching preferences may include rider evaluation preferences, provider evaluation preferences, and provider-rider preferences. The rider evaluation preferences describe parameters for evaluation of a rider to be matched with the flexible user. The rider evaluation preferences can be based on the rider's pick-up location, the rider's destination, the rider's user profile data, the amount of time the rider has been waiting for a ride, a maximum delay time for starting the trip, a maximum distance between the flexible user's start location to the rider's pick-up location, a maximum distance between the flexible user's destination and the rider's destination, a maximum detour distance, a maximum detour time, and/or a minimum trip price to receive for providing a ride to the rider.

The provider evaluation preferences describe parameters for evaluation of a provider to be matched with the flexible user. The provider evaluation preferences can be based on the provider's availability to provide a ride, the provider's current location, the type of the provider, the provider's user profile data, a minimum delay time for starting the trip, and/or a maximum trip price to pay for the ride.

The provider-rider preferences describe parameters for evaluating whether to match the flexible user with either a rider or a provider. The provider-rider preferences can include a designation of a preference for being matched with a rider or a provider, and to what extent the flexible user prefers being matched with a rider or a provider.

In some embodiments, the matching module 160 filters candidate riders and providers based on the matching preferences. For example, the matching module 160 may determine the detour time or distance for the flexible user to provide a ride to possible riders and may exclude riders from consideration whose pick-up location or destination would require the flexible user to exceed a maximum detour time or distance. In some embodiments, the matching module 160 generates matching scores for riders and providers. A matching score is an evaluation of the match between the flexible user and a possible rider or provider. For example, a rider that would require a greater detour distance/time might have a lower score than a rider that would require a shorter detour distance/time. The matching module 160 may then match the flexible user with the rider or provider that has the highest score. In some embodiments, the matching module 160 uses a utility function to generate the matching scores. The utility function may include a set of factors that are adjusted by a corresponding set of weights. The weightings may be based on the matching preferences of the flexible user. For example, if the flexible user indicates that they would prefer to be matched with a provider over a rider, the utility function may weigh providers more highly than riders.

The matching module 160 can match the flexible user with a rider or a provider based on information in the flexible trip request (e.g., the flexible user's start location and destination), user profile data for the flexible user stored by the user profile store 150, and travel data stored by the travel data store 140. The matching module 160 can also use the supply of providers and demand of trips to determine whether to match the flexible user with a rider or a provider. For example, if the geographic region within which the flexible user wants to take a trip has a high supply of providers (e.g., there are many providers who are available to provide transportation to riders based on the state of the providers or providers' applications) relative to the rider demand for providers, the matching module 160 may match the flexible user with a provider to provide transportation to the flexible user. Similarly, if the geographic region has a high rider demand for providers (e.g., there are many riders who have indicated interest in requesting a trip by opening the client application, by interacting with the client application, and/or by having submitted trip requests to the travel coordination system 120 but have not yet have been provided transportation) relative to the supply of providers, the matching module 160 may match the flexible user with one of the riders to provide transportation to the rider. In some embodiments, the matching module 160 uses a difference of the provider supply to the trip demand to determine whether to match the flexible user with a provider or with a rider.

The matching module 160 may generate models of the supply of providers and demand for trips to determine provider supply and trip demand. In some embodiments, the provider supply models and trip demand models are generated based on data stored in the travel data store 140. The provider supply models may consider provider supply factors, such as the number of providers in the geographic region, the rate at which providers are coming online/going offline, the rate at which providers are being assigned to riders, the rate at which providers are finishing trips, and/or the historical provider supply in the geographic region. The trip demand models may consider trip demand factors, such as the trip request rate, the assignment request rate, the number of riders currently viewing the client application, the rate at which riders who open the client application on the client device 100 submit a trip request, and/or the historical trip demand in the geographic region.

In some embodiments, the matching module 160 establishes a preferred and dispreferred matching group of users with which to match the flexible user. The matching module 160 may first determine whether the flexible user can be matched with a user of the preferred matching group and, if so, may match the flexible user with a user from the preferred matching group. If a match cannot be made with a user from the preferred matching group, the matching module 160 may then match the flexible user with an available user from the dispreferred matching group. For example, if the preferred matching group is riders and the dispreferred matching group is providers, the matching module 160 determines if a flexible user can be matched with a rider and, if so, matches the flexible user with a rider without determining whether the flexible user can be matched with provider. In this example, the matching module 160 might determine whether the flexible user can be matched with a provider only if there are no riders with which the flexible user can be matched. In some embodiments, the preferred matching group of users is either riders or providers, and the dispreferred matching group is the other.

The preferred and dispreferred matching groups may be established based on the matching preferences of the flexible user. For example, if the flexible user expresses significant preference to be matched with a provider, the matching module 160 may establish providers as the preferred matching group and riders as the dispreferred matching group. In some embodiments, the matching module 160 establishes the preferred and dispreferred matching groups based on the supply of providers and demand for trips in a geographic region. For example, if trip demand is greater than the provider supply, the matching module 160 may establish riders as the preferred matching group and providers as the dispreferred matching group such that the flexible user is initially is considered for providing rides to riders to reduce the trip demand. Similarly, if provider supply is greater than trip demand, the matching module may establish providers as the preferred matching group and riders as the dispreferred matching group so that one of the available providers can service the flexible user. The preferred and dispreferred matching groups may be established based on current provider supply and trip demand or based on models predicting upcoming provider supply and trip demand.

The user interface generation module 170 provides a frontend interface for the travel coordination system 120 to communicate via the network 110 with the client device 100. The user interface generation module 170 may provide application programming interface (API) functionality to send data directly to native client device operating systems. The user interface generation module 170 may receive and route messages between the travel coordination system 120 and the client device 100. Additionally, the user interface generation module 170 can serve web pages, as well as other web-related content.

The user interface generation module 170 can provide a user interface to the rider for submitting a trip request through the client device 100. The user interface generation module 170 can instruct the client device 100 to display a user interface that enables the rider to specify a pick-up location and a destination. In addition, the user interface generation module 170 may also provide the rider with geographic information for the area around the rider and an interface through which the rider can provide payment information.

In addition, the user interface generation module 170 can also provide a user interface to a user to submit a flexible trip request as a flexible user. The user interface presented to the user may allow the user to specify matching preferences for the flexible trip request. The user interface generation module 170 can also notify the flexible user when the flexible user has been matched with another user, and whether the flexible user has been matched with a rider or a provider.

The user interface generation module 170 can also provide a user interface to a provider through the client device 100. The user interface generation module 170 can send assignment requests to the client device 100 on behalf of the matching module 145 and may receive responses to the assignment requests from the client device 100. The user interface generation module 170 may also provide an interface, via the provider client application, on which the provider's geographic location is displayed, and provide trip directions to the provider when the provider is transporting a rider.

The trip price determination module 180 determines the trip price of a trip coordinated by the travel coordination system 120. The trip price is the price that the rider pays for a trip using the travel coordination system 120 (e.g., price based on time and/or price based on distance for the particular geographic region or location). The trip price may be determined based on various factors for the trip, such as the duration of the trip, the distance traveled in the trip, the pick-up location, the destination, when the trip started, when the time of arrival at the destination, current traffic conditions, the number of passengers on the trip, and/or the type of the provider (e.g., the type of vehicle of the provider) servicing the trip. The trip price may also be determined based on conditions in which the trip occurs, such as the supply of providers and the demand for trips in the geographic region within which the trip takes place. For example, if many providers are available to provide trips as compared to the number of potential riders that may request trips, then the trip price may be lower. Similarly, if the number of riders requesting trips compared to the number of available providers is high, the trip price may be higher. In some embodiments, the trip price is based on how the supply of providers relative to the demand for trips. For example, if the demand for trips within a geographic region is significantly higher than the supply of providers within the geographic region, the trip price may be higher due to the shortage of providers. In some embodiments, the trip price determination module 180 determines a scaling modifier (e.g., a multiplier) based on provider supply and trip demand, and applies the scaling modifier to an initial trip price to determine a final trip price.

The trip price determination module 180 may determine the trip price during the trip or after the trip has completed based on information gathered during the trip. In some embodiments, the trip price determination module 180 predetermines the trip price before the trip takes place. For example, the trip price determination module 180 may establish a flat rate for trips that are taken regularly by a large number of riders, and therefore the trip determination module 180 can determine the trip price before the trip takes place based on the pick-up location and the destination.

In some embodiments, the trip price determination module 180 adjusts the trip price for a flexible user who submitted a flexible trip request. For example, the trip price determination module 180 may establish a discount or flat rate for a flexible user who is matched with a provider if that flexible user submitted a flexible trip request. Similarly, the trip price determination module 180 may guarantee a minimum trip price for a flexible user that is matched with a rider.

Matching a Flexible User with Another User

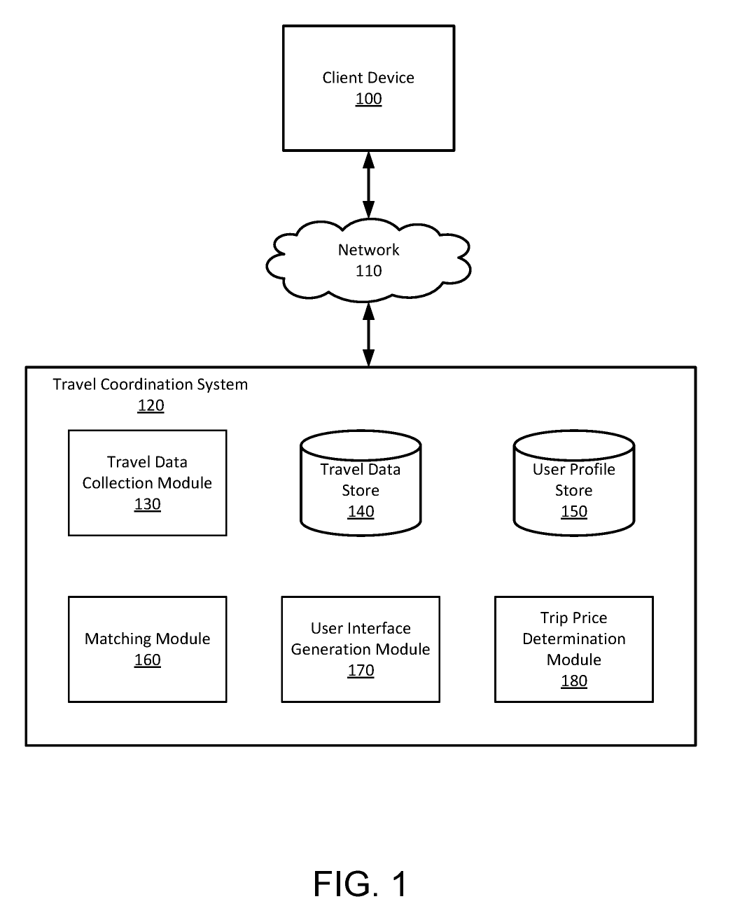

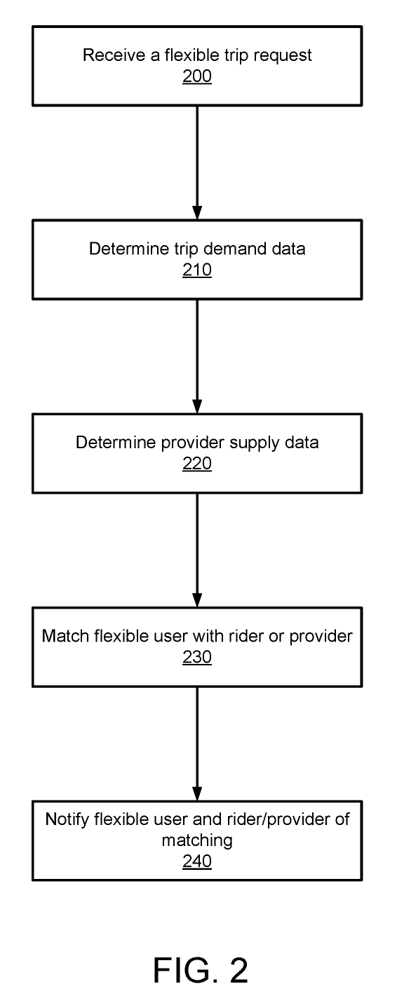

FIG. 2 illustrates a method for matching a flexible user with another user, in accordance with some embodiments. Alternate embodiments may contain more, fewer, or different steps and may perform the steps in a different order.

The example method shown in FIG. 2 may be performed, for example, by the travel coordination system 120. The travel coordination system 120 receives 200 a flexible trip request from a client device of a flexible user. The flexible trip request indicates that the flexible user can be matched with a rider or a provider, and can include a first start location and a first destination location. In some embodiments, the flexible trip request also includes matching preferences for selecting which user to match with the flexible user.

The travel coordination system 120 determines 210 trip demand data corresponding to a demand for trips within the geographic region containing the first start location and the first destination location. The trip demand data can include a trip request from a rider, which specifies a second start location and a second destination location. The trip demand data may further include other trip demand factors, such as the trip request rate, the assignment request rate, the number of riders currently viewing the client application, the rate at which riders who open the client application on the client device 100 submit a trip request, and/or the historical trip demand in the geographic region.

The travel coordination system 120 determines 220 provider supply data corresponding to a supply of providers within the geographic region. The provider supply data can include a provider that is available to transport the flexible user from the first start location to the first destination. The provider supply data may further include provider supply factors, such as the number of providers in the geographic region, the rate at which providers are coming online/going offline, the rate at which providers are being assigned to riders, the rate at which providers are finishing trips, and/or the historical provider supply in the geographic region. Although the example of FIG. 2 describes the travel coordination system 120 determining the provider supply data after determining the trip demand data, in other examples, the travel coordination system 120 can determine the provider supply data before determining the trip demand data or determine both concurrently. Still further, alternatively, the travel coordination system 120 can continually and/or periodically determine the provider supply data and the trip demand data, such that the travel coordination system 120 can have close to up-to-date or real-time data when a flexible trip request is received.

The travel coordination system 120 matches 230 the flexible user with either a rider or a provider. In some embodiments, the travel coordination system 120 generates matching scores for candidate riders and providers and matches the flexible user with one of the candidate riders or candidate providers based on the generate scores. For example, the travel coordination system may match the flexible user with rider or provider with the highest matching score. In some embodiments, the travel coordination system 120 identifies candidate riders and candidate providers to be matched with the flexible user, generates matching scores for those riders and providers, and selects the rider or provider with the highest matching score. Alternately, the travel coordination system 120 may score the candidate riders and providers separately, identify a best rider and best provider with the highest scores among the candidate riders and candidate providers respectively, and match the flexible user with either the best rider or the best provider based on the provider supply/trip demand or matching preferences.

In some embodiments, the travel coordination system 120 generates the matching scores using a utility function. The utility function may include factors that are adjusted based on a corresponding set of weights. The set of weights may be based on matching preferences stored by the travel coordination system 120 or provided by the flexible user. For example, if the flexible user indicates a preference for being matched with a rider over a provider, then the utility function may weigh riders more heavily than providers. The set of weights also may be based on the provider supply and the trip demand determined by the travel coordination system 120. For example, if trip demand is high and provider supply is low, the travel coordination system may match the flexible user with a rider rather than with a provider to service the high demand for trips.

If the travel coordination system 120 matches the flexible user with the rider, the travel coordination system 120 notifies 240 the flexible user and the rider of the matching. In some embodiments, the travel coordination system 120 sends an assignment request to the flexible user's client device 100 to service a trip request submitted by the rider. If the travel coordination system 120 matches the flexible user with the provider, the travel coordination system 120 notifies 240 the flexible user and the provider of the matching. In some embodiments, the travel coordination system 120 sends an assignment request to the provider to service the flexible trip request from the flexible user.

Matching a Flexible User with a Preferred Matching Group

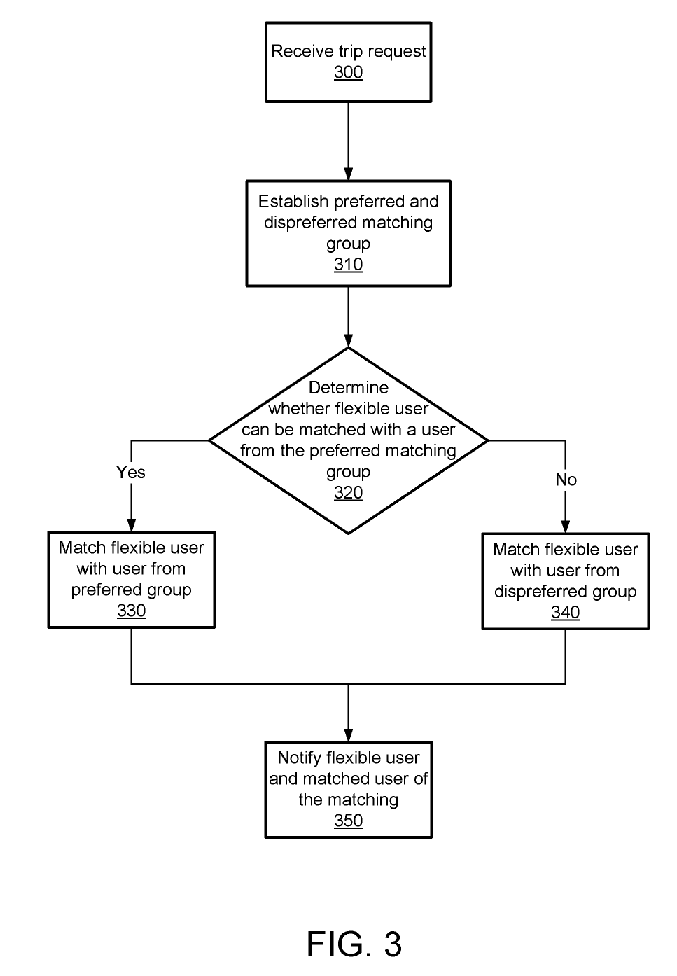

FIG. 3 illustrates a method for matching a flexible user with another user from a preferred matching group, in accordance with some embodiments. Alternate embodiments to FIG. 3 may include more, fewer, or different steps, and the steps may be performed in an order different from what is illustrated in FIG. 3.

The travel coordination system 120 receives 300 a flexible trip request from a client device of flexible user. The flexible trip request indicates that the flexible user can be matched with a rider or a provider, and includes a start location and a destination location. In some embodiments, the flexible trip request also includes matching preferences for selecting which user to match with the flexible user.

The travel coordination system 120 establishes 310 a preferred and dispreferred matching group. In some embodiments, the preferred matching group is one of riders and providers, and the dispreferred matching group is the other of riders and providers. The preferred and dispreferred matching groups may be established based on provider supply and trip demand. For example, if provider supply is greater than trip demand, the travel coordination system 120 may establish providers as the preferred matching group and riders as the dispreferred matching group. In some embodiments, the travel coordination system 120 establishes the preferred and dispreferred matching group based on preferences stored by the travel coordination system 120 or provided by the flexible user in a flexible trip request. For example, if the travel coordination system 120 stores preferences to match flexible users with riders, the travel coordination system 120 may establish riders as the preferred matching group and providers as the dispreferred matching group. Similarly, if the flexible user providers matching preferences that indicate a strong preference to be matched with a rider, the travel coordination system 120 may establish riders as the preferred matching group and providers as the dispreferred matching group.

The travel coordination system 120 determines 320 if the flexible user can be matched with a user from the preferred matching group. In some embodiments, the travel coordination system 120 generates matching scores for members of the preferred matching group and, if a member of the preferred matching group has a sufficiently high matching score, the travel coordination system 120 matches the flexible user with the member with the high matching score. The travel coordination system 120 may apply filters to the members of the preferred matching group and may select from the members that remain after applying all filters to the preferred matching group. If no members in the preferred matching group remain after applying the filters, then the travel coordination system 120 selects from the dispreferred matching group.

If the travel coordination system 120 can match the flexible user with a user of the preferred matching group, the travel coordination system 120 matches 330 the flexible user with the user of the preferred matching group. If the travel coordination system 120 cannot match the flexible user with a user of the preferred matching group, the travel coordination system 120 matches 340 the flexible user with the user of the dispreferred matching group.

The travel coordination system 120 notifies 350 the flexible user and the user matched with flexible user of the matching. In some embodiments, if the travel coordination system 120 matches the flexible user with a rider, the travel coordination system 120 sends an assignment request to the flexible user's client device 100 to service a trip request submitted by the rider. In some embodiments, if the travel coordination system 120 matches the flexible user with the provider, the travel coordination system 120 sends an assignment request to the provider to service the flexible trip request from the flexible user.

### Example User Interfaces

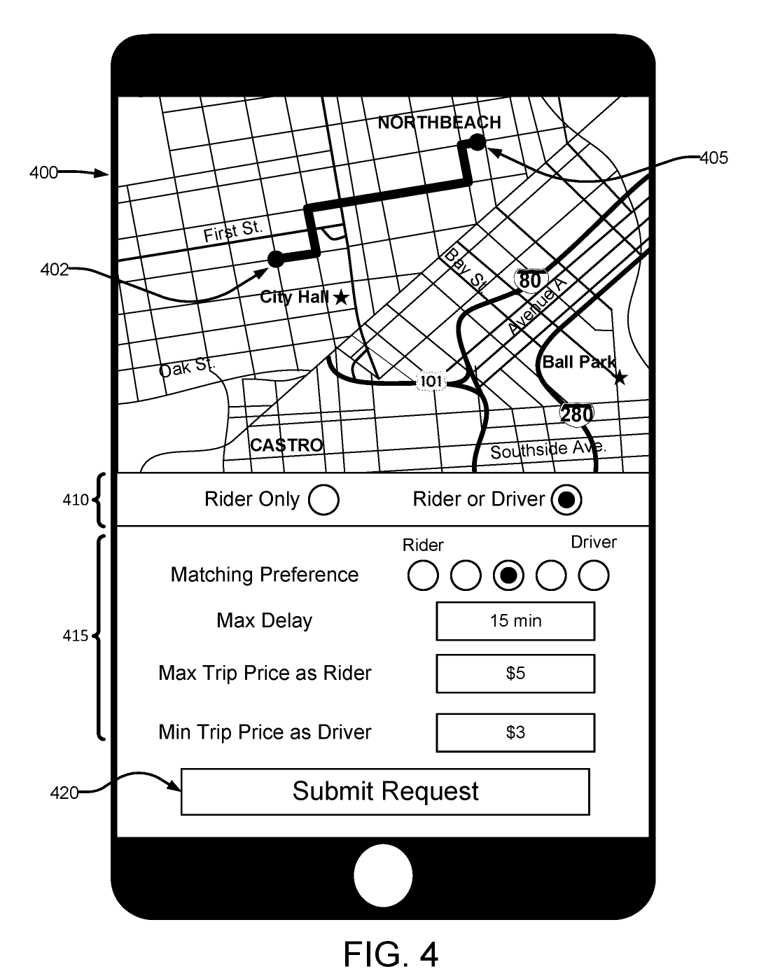

FIG. 4 illustrates an example user interface to submit a flexible trip request to a travel coordination system, in accordance with some embodiments. The flexible trip requests submitted using the user interface illustrated in FIG. 4 may be submitted in accordance with the methods as described in FIGS. 1, 2, 3A, and/or 3B. The user interface illustrated in FIG. 4 may be presented to a user through a mobile application operating on a client device.

The user interface presents a map 400 of the geographic region around the user. The user interface also displays the start location 402 and the destination 405 specified by the user. The user interface provides an option 410 for the user to decide whether to submit a trip request or a flexible trip request. This permits the user to indicate, for example, whether to be treated as a rider only or as a flexible user for the trip. Alternatively, in another example, the flexible trip request option can correspond to a service type or vehicle type selectable by the user. By choosing to submit a flexible trip request, the user is presented with matching preferences 415 to submit with the flexible trip request. For example, the user interface described by FIG. 4 allows the user to indicate a preference for being matched with a rider or a provider, a maximum delay time for transporting a rider, a maximum price to pay if the flexible user were matched with a provider, and a minimum price to be paid if the flexible user were matched with a rider. The user interface also provides an interface 420 for submitting the flexible trip request to the travel coordination system 120 with the specified preferences. In alternative examples, the user interface may include different features (e.g., may include a payment profile selection or lack the matching preference scale, etc.).

### Example Hardware Architecture

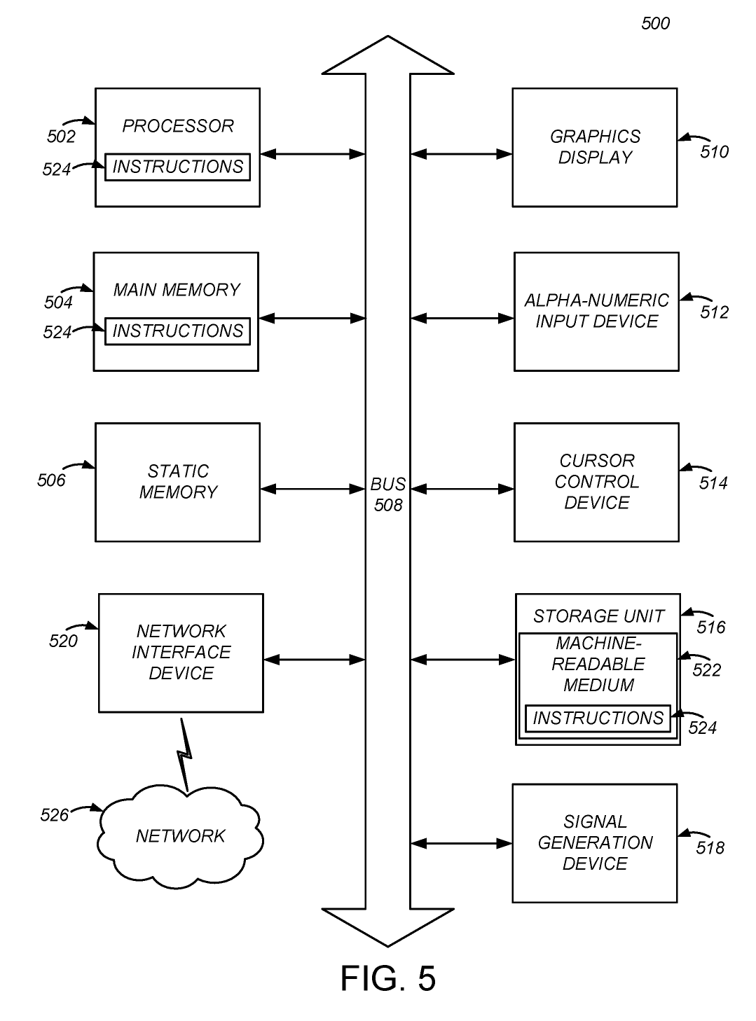

FIG. 5 illustrates an example hardware architecture of a computer system 500, such as a travel coordination system 120, in accordance with some embodiments. The illustrated computer system 500 includes a processor 502, a main memory 504, a static memory 506, a bus 508, a graphics display 510, an alpha-numeric input device 512, a cursor control device 514, a storage unity 516, a signal generation device 518, and a network interface device 520. In alternative configurations, additional, fewer, or different components may be included in computer system 500 than those described in FIG. 5.

The computer system 500 can be used to execute instructions 524 (e.g., program code or software) for causing the computer system 500 to perform any one or more of the methodologies (or processes) described herein. In alternative embodiments, the computer system 500 operates as a standalone device or a connected (e.g., networked) device that connects to other computer systems 500. In a networked deployment, the computer system 500 may operate in the capacity of a server machine.

The computer system 500 may be a server computer, a client computer, a personal computer (PC), a tablet PC, a set-top box (STB), a smartphone, an internet of things (IoT) appliance, a network router, switch or bridge, or any machine capable of executing instructions 524 (sequential or otherwise) that specify actions to be taken by that machine. Further, while only a single machine is illustrated in FIG. 7, the term “computer system” shall also be taken to include any collection of machines that individually or jointly execute instructions 524 to perform any one or more of the methodologies discussed herein.

The example computer system 500 includes one or more processing units (generally processor 502). The processor 502 is, for example, a central processing unit (CPU), a graphics processing unit (GPU), a digital signal processor (DSP), a controller, a state machine, one or more application specific integrated circuits (ASICs), one or more radio-frequency integrated circuits (RFICs), or any combination of these. The computer system 500 also includes a main memory 504. The computer system may include a storage unit 516. The processor 502, memory 504, and the storage unit 516 communicate via a bus 508.

In addition, the computer system 500 can include a static memory 506, a display driver 510 (e.g., to drive a plasma display panel (PDP), a liquid crystal display (LCD), or a projector). The computer system 500 may also include alphanumeric input device 512 (e.g., a keyboard), a cursor control device 514 (e.g., a mouse, a trackball, a joystick, a motion sensor, or other pointing instrument), a signal generation device 518 (e.g., a speaker), and a network interface device 520, which also are configured to communicate via the bus 508.

The storage unit 516 includes a machine-readable medium 522 on which is stored instructions 524 (e.g., software) embodying any one or more of the methodologies or functions described herein. The instructions 524 may also reside, completely or at least partially, within the main memory 504 or within the processor 502 (e.g., within a processor's cache memory) during execution thereof by the computer system 500, the main memory 504 and the processor 502 also constituting machine-readable media. The instructions 524 may be transmitted or received over a network 526 via the network interface device 520.

While machine-readable medium 522 is shown in an example embodiment to be a single medium, the term “machine-readable medium” should be taken to include a single medium or multiple media (e.g., a centralized or distributed database, or associated caches and servers) able to store the instructions 524. The term “machine-readable medium” shall also be taken to include any medium that is capable of storing instructions 524 for execution by the machine and that cause the machine to perform any one or more of the methodologies disclosed herein. The term “machine-readable medium” includes, but not be limited to, data repositories in the form of solid-state memories, optical media, and magnetic media.

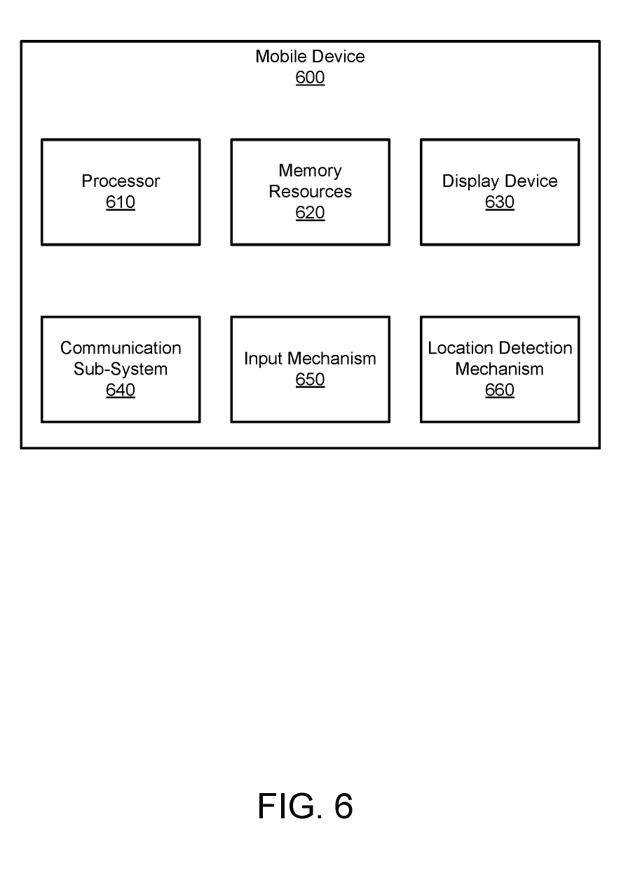

FIG. 6 illustrates a mobile computing device upon which examples described herein may be implemented. In one example, a mobile device 600 may correspond to a mobile computing device, such as a cellular device that is capable of telephony, messaging, and data services. The mobile device 600 can correspond to a client device 100. Examples of such devices include smartphones, handsets, or tablet devices for cellular carriers. The computing device 600 includes a processor 610, memory resources 620, a display device 630 (e.g., such as a touch-sensitive display device), one or more communication sub-systems 640 (including wireless communication sub-systems), input mechanisms 650 (e.g., an input mechanism can include or be part of the touch-sensitive display device), and one or more location detection mechanisms (e.g., GPS component) 660. In one example, at least one of the communication sub-systems 640 sends and receives cellular data over data channels and voice channels.

The processor 610 is configured with software and/or other logic to perform one or more processes, steps and other functions described with implementations, such as described by FIGS. 1 through 4, and elsewhere in the application. The processor 610 is configured, with instructions and data stored in the memory resources 620, to operate a client application as described in FIGS. 1 through 4. Instructions for operating the client application in order to display various user interfaces can be stored in the memory resources 620 of the computing device 600.

The GPS component 660 can determine location information, such as the geographic location of the mobile device 600. The geographic location of the mobile device 600 can be wirelessly transmitted to the travel coordination system 120 via the communication subsystems 640 periodically or as part of ordinary communication with the travel coordination system 120. The travel coordination system 120 can receive the geographic location from the mobile device 600 (or a user-specific location data point corresponding to a selected pickup location) and can select a provider to service a trip request from a rider based on the geographic location. The travel coordination system 120 can also transmit a notification to the mobile device 600 via the communication sub-systems 640 if the trip price estimate is less than a target price set by the rider and the travel coordination system is able to service the trip request. The notification can be processed by the processor 610 to provide the notification as content as part of a user interface on the display 630.

For example, the processor 610 can provide a variety of content to the display 630 by executing instructions and/or applications that are stored in the memory resources 620. One or more user interfaces can be provided by the processor 610, such as a user interface for the service application. While FIG. 6 is illustrated for a mobile device, one or more examples may be implemented on other types of devices such as laptop and desktop computers.

### Additional Configurations

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed is:

1. A method comprising:
receiving, at a travel coordination system, a flexible trip request from a client device of a flexible user, the flexible trip request including a first start location and a first destination location;
determining trip demand data corresponding to a demand for trips from riders within a geographic region containing the first start location and the first destination location, the trip demand data comprising a trip request from a client device of a rider, the trip request comprising a second start location and a second destination location;
determining provider supply data corresponding to a supply of providers within the geographic region, the provider supply data comprising a provider available to provide transportation;
matching the flexible user with one of the rider or the provider based on the trip demand data, the provider supply data, and matching preferences specified by the flexible user; and
assigning the flexible user to complete the trip by:
when the flexible user is matched with the rider, sending an assignment request to the flexible user to provide transportation to the rider from the second start location to the second destination location; or
when the flexible user is matched with the provider, sending an assignment request to the provider to provide transportation to the flexible user from the first start location to the first destination location.

2. The method of claim 1, wherein the trip demand data comprises at least one of: a trip request rate, an assignment request rate, a number of riders currently viewing a client application for the travel coordination system, a rate at which riders who open the client application submit a trip request, or historical trip demand in the geographic region.

3. The method of claim 1, wherein the provider supply data comprises at least one of: a number of providers in the geographic region, a rate at which providers are coming online, a rate at which providers are going offline, a rate at which providers are being assigned to riders, a rate at which providers are finishing trips, or historical provider supply in the geographic region.

4. The method of claim 1, wherein the matching preferences are included in the flexible trip request.

5. The method of claim 1, wherein the flexible user is matched with one of the rider or the provider based on a difference in the demand for trips and the supply of providers in the geographic region.

6. The method of claim 1, wherein the matching preferences include at least one of: a preference for being matched with either a rider or a provider, a maximum detour time, a maximum detour distance, or a departure timeframe.

7. The method of claim 1, wherein matching the flexible user with one of the rider and the provider further comprises:
establishing a preferred matching group and a dispreferred matching group for the flexible user, the preferred matching group and dispreferred matching group selected from a provider group and a rider group; and
matching the flexible user with one of the rider or the provider based on the established preferred matching group and dispreferred matching group.

8. The method of claim 7, wherein the preferred matching group and the dispreferred matching group are established based on a difference in the supply of providers and the demand for trips in the geographic region.

9. The method of claim 1, wherein matching the flexible user with one of the rider or the provider further comprises:
generating a matching score for each of the rider and the provider based on the matching preferences; and
selecting the rider or the provider based on the matching score of the rider and the matching score of the provider.

10. The method of claim 9, wherein the matching scores are generated using a utility function.

11. The method of claim 1, further comprising presenting, to the flexible user through the client device, a user interface for submitting the flexible trip request.

12. A non-transitory computer-readable storage medium comprising instructions encoded thereon that, when executed by a processor, cause the processor to:
receive a flexible trip request from a client device of a flexible user, the flexible trip request including a start location and a destination location;
establish a preferred matching group and a dispreferred matching group for the flexible user, the preferred and dispreferred matching group selected from a provider group and a rider group;
determine whether the flexible user can be matched with a user in the preferred matching group based on matching preferences associated with the flexible user;
responsive to determining that the flexible user can be matched with the user of the preferred matching group, match the flexible user with the user of the preferred matching group;
responsive to determining that the flexible user cannot be matched with the user of the preferred matching group, match the flexible user with a user of the dispreferred matching group;
responsive to matching the flexible user with a user of the rider group, send an assignment request to the flexible user to provide transportation to the rider; and
responsive to matching the flexible user with a user of the provider group, send an assignment request to the provider to provide transportation to the flexible user.

13. The non-transitory computer-readable storage medium of claim 12, wherein the preferred matching group is the rider group and the dispreferred matching group is the provider group.

14. The non-transitory computer readable storage medium of claim 12, wherein the preferred matching group is the provider group and the dispreferred matching group is the rider group.

15. The non-transitory computer-readable storage medium of claim 12, wherein the preferred matching group and the dispreferred matching group are established based on (i) provider supply data corresponding to a supply of providers within a geographic region containing the start location and the destination location, and (ii) trip demand data corresponding to a demand for trips from riders within the geographic region.

16. The non-transitory computer-readable storage medium of claim 15, further comprising instructions that cause the processor to:
determine a difference between the supply of providers and the demand for trips;
responsive to the supply of providers being greater than the demand for trips, establishing the provider group as the preferred matching group and the rider group as the dispreferred matching group; and
responsive to the supply of providers being less than the demand for trips, establishing the rider group as the preferred matching group and the provider group as the dispreferred matching group.

17. The non-transitory computer-readable storage medium of claim 12, wherein the matching preferences are included in the flexible trip request.

18. The non-transitory computer-readable storage medium of claim 12, wherein the matching preferences include at least one of: a preference for being matched with either a rider or a provider, a maximum detour time, a maximum detour distance, or a departure timeframe.

19. The non-transitory computer-readable storage medium of claim 12, further comprising instructions that cause the processor to: present, to the flexible user through the client device, a user interface for submitting the flexible trip request.

20. A method comprising:
receiving, at a travel coordination system, a plurality of flexible trip requests from client devices of a plurality of flexible users, each flexible trip request including a start location and a destination location for a flexible user;
determining trip demand data corresponding to a demand for trips from riders within a geographic region containing the start locations and the destination locations for the flexible users, the trip demand data comprising a plurality of trip requests from client devices of a plurality of riders, each trip request comprising a rider start location and a rider destination location;
determining provider supply data corresponding to a supply of providers within the geographic region, the provider supply data comprising a plurality of providers available to provide transportation;
matching each of the plurality of flexible users with a rider of the plurality of riders or a provider of the plurality of providers based on the trip demand data, the provider supply data, and matching preferences specified by the flexible user;
responsive to matching a flexible user of the plurality of flexible users with a rider of the plurality of riders, assigning the flexible user to provide transportation to the rider from the rider start location of the rider to the rider destination location of the rider; and
responsive to matching a flexible user of the plurality of flexible users with a provider of the plurality of riders, assigning the provider to provide transportation to the flexible user from the start location of the flexible user to the destination location of the flexible user.
